(19) United States
(12) Patent Application Publication
(10) Pub. No.: US 2007/0038401 A1
(43) Pub. Date: Feb. 15, 2007

(54) Auto-calibration algorithm with hysteresis correction

(75) Inventor: David W. Cripe, Chatham, IL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/302,911

(22) Filed: Dec. 14, 2005

Related U.S. Application Data
(60) Provisional application No. 60/708,063, filed on Aug. 12, 2005.

(51) Int. Cl. G01D 18/00

(52) U.S. Cl. 702/104

(57) ABSTRACT

A method of calibrating a magnetoelastic force sensor includes the steps of mating a force transducer with a magnetometer, applying a force to the force transducer at each of a plurality of defined calibration points, recording output signals indicative of a magnetic field generated at each of the defined calibration points communicated to each of the at least two channels, and determining a correction factor for each of the at least two channels based on the recorded output signals for each of the defined calibration points.

### CROSS REFERENCE TO RELATED APPLICATION

The application claims priority to U.S. Provisional Application No. 60/708,063, which was filed on Aug. 12, 2005.

### BACKGROUND OF THE INVENTION

This invention generally relates to a method of calibrating a magnetometer for a force sensor. More particularly, this invention relates to a method of calibrating a magnetometer for a force sensor for decreasing variability.

A type of force sensor includes a transducer element that includes a magnetoelastic material containing two adjacent, oppositely circumferentially magnetically polarized axial regions, that each produces a magnetic field responsive to an applied force. This magnetic field is divergent in nature, for detection by a magnetometer circuit configured as a magnetic gradiometer. The generated magnetic field is then detected by the magnetometer that provides an output signal indicative of an applied force, and provides a minimal sensitivity to non-divergent extraneous magnetic fields, such as that of the Earth.

A known magnetometer for application with such a force transducer includes independent magnetometer sections corresponding to an upper and lower axial section of the force transducer. The voltage difference of these two outputs provide the gradiometric senor output. Disadvantageously, although the individual magnetometer sections are produced to the same specifications, some differences occur and therefore can cause an asymmetrical sensitivity of the magnetic sense elements allowing non-zero sensitivity of the sensor to non-divergent magnetic fields. Such a phenomenon reduces the reliability and accuracy of the sensor. Further, hysteresis present within the magnetoelastic element may also prevent the transducer from returning to an original zero point after the application and subsequent removal of a force stimulus, also disrupting and reducing sensor accuracy.

Accordingly, it is desirable to design and develop a method of calibrating a magnetometer that highly attenuates the sensitivity of the sensor to unwanted, extraneous magnetic fields.

It is also desirable to design and develop a method of calibrating a force sensor magnetometer that corrects for hysteresis that may be present within the magnetoelastic sense element.

### SUMMARY OF THE INVENTION

An example method of calibrating a magnetoelastic force sensor according to this invention includes the step of mating a force transducer with a magnetometer, applying a force to the force transducer at each of a multiple of defined calibration points, recording output signals indicative of a magnetic field generated at each of the defined calibration points communicated to each of the at least two channels, and determining a correction factor for each of the at least two channels based on the recorded output signals for each of the defined calibration points.

An example torque sensor assembly calibrated according to the method steps of this invention includes a torque transducer with a magnetoelastic ring. The magnetoelastic ring produces a divergent magnetic field responsive to the application of torque. A magnetometer assembly includes at least two sense elements disposed adjacent to the torque transducer.

The method includes the initial step of mating the force transducer with the magnetometer. The magnetometer includes at least two channels that receive the signals indicative of the magnetic field generated by the force transducer responsive to application of force. A series of known forces are applied to the torque transducer and recorded as calibration points. The calibration points are indicative of a magnetic field generated by the magnetoelastic ring. The gain of each of the channels is then matched so that when they are summed there is no sensitivity to ambient magnetic fields. Calibration coefficients are then determined for each channel such that the ratio between the gain in the channels is equal to a ratio between differential voltages obtained with the torque transducer assembly pointing sequentially toward a north and south polar, non-divergent magnetic field.

Subsequently coefficients used for compensation for system hysteresis are calculated based on measured hysteresis of the system measured as the shift in zero-force output of the system prior to and after application of a stimulus force.

Temperature compensation of the sensor system is also provided by allowing these coefficients to be modified according to the measured value of an associated temperature sensor.

Accordingly, the method according to this invention provides for improved accuracy of a force sensor assembly and magnetometer.

These and other features of the present invention can be best understood from the following specification and drawings, the following of which is a brief description.

### BRIEF DESCRIPTION OF THE DRAWINGS

FIG. 1 is a schematic illustration of an example torque transducer according to this invention.

FIG. 2 is a graph illustrating and example relationship between an applied force and an output voltage for an example torque transducer.

FIG. 3 is a schematic illustration of example method steps for calibrating a torque transducer according to this invention.

### DETAILED DESCRIPTION OF THE PREFERRED EMBODIMENT

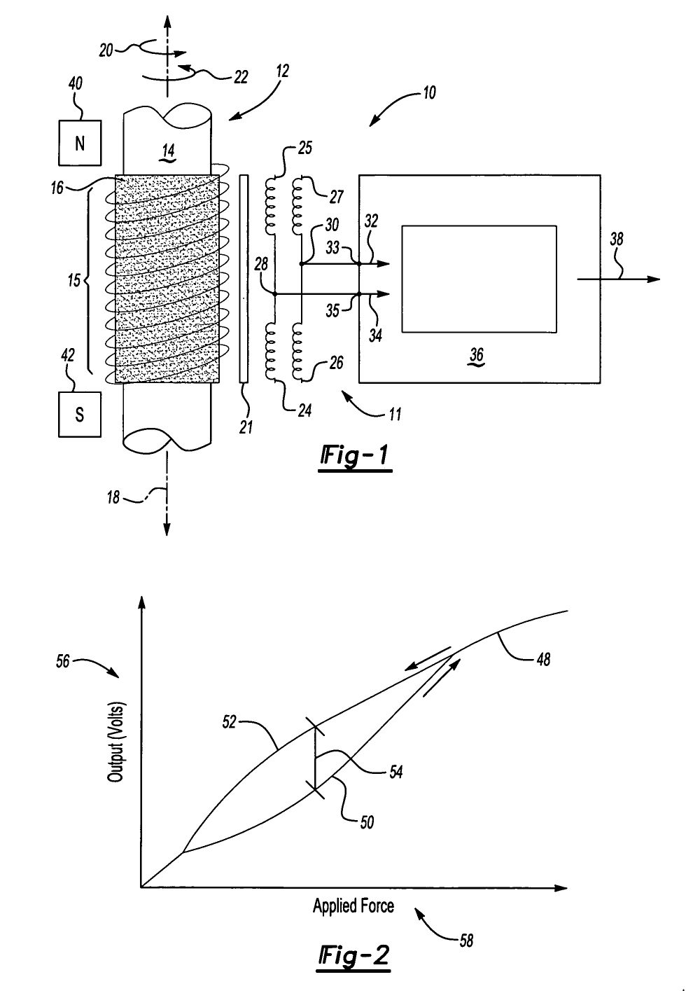

Referring to FIG. 1, a torque sensor assembly 10 is schematically shown and includes a torque transducer 12 disposed about an axis 18. The torque transducer 12 includes a shaft 14 with a magnetoelastic ring 16. The magnetoelastic ring 16 produces a magnetic field 15 responsive to the application of torque on the shaft 14. A magnetometer assembly 11 includes an inductor 21 disposed adjacent the torque transducer 12 that is magnetically saturated by a coil assembly. The coil assembly includes upper inner and outer coils 25, 27 and lower inner and outer coils 24, 26. The inner coils 25, 24 are configured to generate a magnetic field equal and opposite to a magnetic field generated by the outer coils 26, 27.

A controller 36 energizes the coils 24, 25, 26, 27 with an alternating current to generate an alternating magnetic field. The alternating magnetic field causes a magnetic saturation of the inductor 21. When a torque is applied to the torque transducer 12, the generated magnetic field 15 is superimposed on to the inductor 21. The superimposition of the magnetic field 15 causes an asymmetry in magnetic fields between upper coils 25, 27 and the lower coils 24, 26. The asymmetry is detected as a voltage signal across nodes 28, 30. The voltage signals 32, 34 are then utilized to determine a magnitude of applied torque.

Accurate operation of the torque transducer assembly 10 depends on the alignment and calibration of the coil assembly with the torque transducer 12. A method according to this invention provides for the accurate calibration of the torque transducer to the coil assembly and the controller 36. This is accomplished by mating the torque transducer 12 with the controller 36 and then determining a series of calibration coefficients.

Referring to FIG. 2, calibration of the torque transducer 12 provides for the accommodation of hysteresis in the sensor assembly. FIG. 2 is a graph representing a relationship 48 between an applied force 58, and a voltage output 56. The application of a force in a first direction provides a relationship between force and output indicated by line 50. The release of force from a high point results in another relationship indicated at 52. A gap 54 between the relationship for the application of force 50 and the release of force 52 can cause undesirable inaccuracies. However, this gap 54 can be calibrated and accommodated by the method according to this invention.

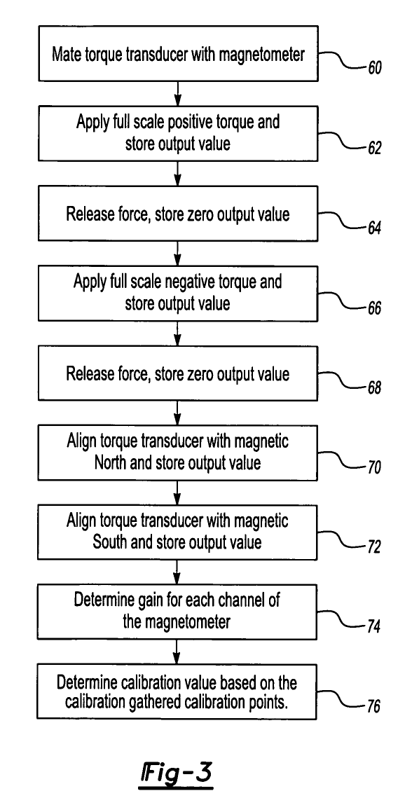

Referring to FIG. 3, the method includes the initial step of mating the force transducer 12 with the magnetometer 11 as indicated at 60. The magnetometer 11 includes at least two channels 33, 35 that receive the signals 32, 34 indicative of the magnetic field 15 generated by the force transducer 12 responsive to application of force. A first known force 20 is applied to the torque transducer 12 in a first direction as is indicated at 62. This provides a calibration point. In this example the first force comprises a full-scale positive torque applied to the torque transducer 12. The first force 20 is then released and the torque transducer 12 allowed to move back to a zero position as indicated at 64. A voltage output is recorded at this zero-force point as another calibration point. A second force 22 is applied to the torque transducer 12 in a second direction opposite to the first direction and another calibration point is recorded as is indicated at 66 and 68. In this example, the second force 22 is a full force in a negative torque direction. The calibration points are voltage values that are indicative of a magnetic field generated by the magnetoelastic ring 16. The calibration points also reveal any difference that may be present between the actual applied force value 20, 22 and the actual reading obtained from the torque transducer.

The gain of each of the channels 33, 35 can then be matched so that when they are summed there is no sensitivity to ambient magnetic fields. Output values are obtained with the torque transducer assembly 10 facing a magnetic north pole 40 and a magnetic south pole 42 (FIG. 1) as indicated at 70 and 72. Accordingly, calibration points are required for pointing the torque transducer assembly 10 toward magnetic north 40 and taking a calibration point. Further, the torque transducer 12 is then pointed in a direction indicative of magnetic south 42 and another calibration point determined. The calibration points are determined as an output value for each of the outputs 32 and 34 from each of the nodes 28, 30.

A correction factor or bias is then determined as indicated at 74 such that the ratio between the gain in the channels 33 and 35 is equal to a ratio between differential voltages obtained with the torque transducer assembly 12 pointing toward the north 40 and south 42. That is a gain for each of the two channels 28,30 is set such that a ratio between the first channel 28 and the second channel 30 is equal to a ratio between an output value with the torque transducer assembly 10 facing north and an output value with the torque transducer facing toward the south magnetic pole 42.

The method also includes the step of determining a hysteresis value based on the calibration values obtained from the first and second forces 20, 22 as is indicated at 76. This is accomplished by determining a span between output values 32, 34 for each calibration point received by each of the two channels 33, 35. Utilizing the span, a calibration coefficient or correction value is determined as a percentage of the span. The determination of the hysteresis correction value includes combining the span with a backlash value indicative of a difference between a hysteresis-containing signal and a desired output value.

The hysteresis correction values are determined using known mathematical compensation techniques such as Prandt-Ishlinskyi Operators. As appreciated, the specific mathematical techniques for determining the hysteresis correction factors are application specific and tailored to the specific torque transducer assembly 10.

The method also includes determination of a temperature coefficient of the sensor system. The determination of temperature coefficient provides a correction factor to accommodate operation at varying temperatures and the effects that such temperature changes have on output voltages to the channels 33 and 35. Temperature compensation values are determined by obtaining temperature values at known time intervals along with voltage values. A thermal correction factor is then determined utilizing known relationships between temperature, resistance and voltage and applied to the outputs 32, 34.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of calibrating a magnetoelastic force sensor comprising the steps of:
a) mating a force transducer with a magnetometer, wherein the magnetometer includes at least two channels that receive signals indicative of a magnetic field generated by the force transducer responsive to application of force;
b) applying a desired magnitude of force to the force transducer at each of a plurality of defined calibration points;
c) recording output signals indicative of a magnetic field generated at each of the defined calibration points communicated to each of the at least two channels; and
d) determining a correction factor for each of the at least two channels based on the recorded output signals for each of the defined calibration points.

2. The method as recited in claim 1, wherein the magnetometer comprises a microcontroller and the at least two channels receive a signal from a first coil and a second magnetic sense element disposed to detect the magnetic field generated by the force transducer.

3. The method as recited in claim 1, including pointing the magnetoelastic force sensor toward magnetic north and storing a north output value for each of the at least two channels, then pointing the magnetoelastic force sensor toward magnetic south and storing a south output value for each of the two channels.

4. The method as recited in claim 3, wherein the correction factor is determined relative to a ratio between the north output value and the south output value.

5. The method as recited in claim 3, including determining a gain for each of the two channels such that a ratio between the first channel and the second channel is equal to a ratio between north output value and the south output value.

6. The method as recited in claim 3, wherein the defined calibration points include a maximum applied torque in the first direction, a first zero point recorded after release of the maximum torque in the first direction, a maximum applied torque in a second direction opposite the first direction, and a second zero point recorded after a release of the maximum force from the second direction.

7. The method as recited in claim 4, including determining a hysteresis value, a span between an output at each calibration point received by each of the two channels, and a hysteresis correction value according to a relationship between the span of the output and the hysteresis value.

8. The method as recited in claim 7, wherein the determination of the hysteresis correction value includes combining the span with a backlash value indicative of a difference between a hysteresis containing signal and a desired output value.

9. A method of calibrating a torque transducer assembly comprising the steps of:
a) mating a torque transducer including a magnetoelastic material that generates a magnetic field responsive to an applied torque and a magnetometer comprising a microcontroller including at least two channels receiving output signals indicative of an applied torque;
b) applying a positive torque substantially equal to a positive full scale force value of the torque transducer;
c) applying a negative torque substantially equal to a negative full scale force value for the torque transducer;
d) recording output values corresponding to the positive full scale force and the negative full scale torque; and
e) determining an individual gain for each of the at least two channels of the microcontroller such that when summed each of the at least two channels provide the desired span sensitivity for the sensor system.

10. The method as recited in claim 9, including recording output values to each of the at least two channels indicative of a release of torque from each of the positive full scale force value and the negative full scale value.

11. The method as recited in claim 10. including recording output values to each of the at least two channels with the torque transducer assembly directed toward magnetic north and separately with the torque transducer directed toward magnetic south.

12. The method as recited in claim 11, wherein a ratio of the individual gains for each of the at least two channels is determined to equal a ratio between output values with the torque transducer directed north and the torque transducer directed south.

13. The method as recited in claim 12, including determining a value indicative of hysteresis utilizing the outputs communicated to each of the at least two channels responsive to application of the positive and negative torque, and release of torque.

14. The method as recited in claim 13, including the step of determining a hysteresis correction coefficient based on the determined hysteresis value.

15. The method as recited in claim 14, including the step of determining a span sensitivity coefficient for the torque transducer assembly utilizing a relationship between the hysteresis correction coefficient and a difference between outputs communicated to each of the at least two channels.
